(19) United States
(12) Patent Application Publication
(10) Pub. No.: US 2015/0143028 A1
(43) Pub. Date: May 21, 2015

(54) DATA STORAGE APPARATUS AND OPERATING METHOD THEREOF

(71) Applicant: SK hynix Inc., Gyeonggi-do (KR)

(72) Inventors: Hoe Seung JUNG, Gyeonggi-do (KR); Jong Ju PARK, Gyeonggi-do (KR); Young Jin PARK, Gyeonggi-do (KR)

(73) Assignee: SK hynix Inc., Gyeonggi-do (KR)

(21) Appl. No.: 14/163,886

(22) Filed: Jan. 24, 2014

(30) Foreign Application Priority Data
Nov. 18, 2013 (KR) 10-2013-0139912

(51) Int. Cl. G06F 12/02; G06F 12/10

(52) U.S. Cl. CPC G06F 12/0246; G06F 12/10; G06F 2212/7201; G06F 2212/657
USPC 711/103; 711/206

(57) ABSTRACT

A data storage apparatus includes a translation section suitable for performing a translation operation for translating first address mapping data to second address mapping data, and an operation memory device suitable for storing the second address mapping data.

### CROSS-REFERENCES TO RELATED APPLICATION

The present application claims priority under 35 U.S.C. §119(a) to Korean application number 10-2013-0139912, filed on Nov. 18, 2013, in the Korean Intellectual Property Office, which is incorporated herein by reference in its entirety as set forth in full.

### BACKGROUND

1. Technical Field

Various embodiments relate to a data storage apparatus, and more particularly, to a method for managing address mapping data of the data storage apparatus.

2. Related Art

A paradigm for computer environments has shifted to ubiquitous computing in which a computer is available regardless of time and place. Therefore, portable electronic apparatuses such as cellular phones, digital cameras, or laptop computers have been extensively used. Such portable electronic apparatuses generally use data storage apparatuses using memory devices.

The data storage apparatuses using memory devices have excellent stability and durability because they have no mechanical driving units, have very fast information access speed, and have relatively low power consumption. The data storage apparatuses having such properties include Universal Serial Bus (USB) memory devices, memory cards with various interfaces, and solid state drives (hereinafter, referred to as SSD).

The data storage apparatuses may perform read and write operations at the request of an external apparatus, and may receive logic addresses in this case. The data storage apparatuses may perform an address mapping operation for translating the received logic addresses to physical addresses in the data storage apparatuses. In order to perform the address mapping operation, the data storage apparatuses may manage address mapping data and store the address mapping data in the memory devices. The data storage apparatuses may load the address mapping data to operation memory devices at a required time point, and may use the address mapping data.

### SUMMARY

An operating method of a data storage apparatus for efficiently managing address mapping data is described herein.

In an exemplary embodiment of the present invention, a data storage apparatus may include a translation section suitable for performing a translation operation for translating first address mapping data to second address mapping data; and an operation memory device suitable for storing the second address mapping data.

In another exemplary embodiment of the present invention, a data storage apparatus may include a translation section suitable for performing a translation operation for translating first address mapping data to second address mapping data, a determination section suitable for determining whether to replace the first address mapping data with the second address mapping data based on a size of the second address mapping data, and an operation memory device suitable for storing the second address mapping data or the first address mapping data based on a determination of the determination section.

In further exemplary embodiment of the present invention, an operating method of a data storage apparatus may include translating first address mapping data to second address mapping data, comparing a size of the second address mapping data with a reference size, determining whether to replace the first address mapping data with the second address mapping data based on a result of the comparing, and selectively storing the second address mapping data and the first address mapping data in an operation memory device based on a result of the determining.

A data storage apparatus and an operating method thereof according to an exemplary embodiment of the present invention may efficiently manage address mapping data.

### BRIEF DESCRIPTION OF THE DRAWINGS

Features, aspects, and embodiments are described in conjunction with the attached drawings, in which:

FIG. 1 is a block diagram illustrating a data processing system including a data storage apparatus according to an embodiment of the present invention;

FIG. 2 is a diagram for explaining a method in which a translation section and an inverse translation section of FIG. 1 perform a translation operation and an inverse translation operation, respectively;

FIG. 3 is a flowchart for explaining a first operating method of the data storage apparatus of FIG. 1;

FIG. 4 is a diagram illustrating the flow of data that is transmitted in each step as an operation procedure of FIG. 3 is performed;

FIG. 5 is a flowchart for explaining a second operating method of the data storage apparatus of FIG. 1;

FIG. 6 is a diagram for explaining an operating method according to FIG. 5;

FIG. 7 is a flowchart for explaining a third operating method of the data storage apparatus of FIG. 1;

FIG. 8 is a diagram for explaining an operating method according to FIG. 7;

FIG. 9 is a diagram illustrating the flow of data that is transmitted in each step as an operation procedure of FIG. 7 is performed;

FIG. 10 is a flowchart for explaining a fourth operating method of the data storage apparatus of FIG. 1;

FIG. 11 is a diagram for explaining an operating method according to FIG. 10;

FIG. 12 is a diagram illustrating the flow of data that is transmitted in each step as an operation procedure of FIG. 10 is performed;

FIG. 13 is a flowchart for explaining a method in which the data storage apparatus of FIG. 1 performs backup;

FIG. 14 is a diagram illustrating the flow of data that is transmitted in each step as an operation procedure of FIG. 13 is performed;

FIG. 15 is a block diagram illustrating a data processing system including a data storage apparatus according to another embodiment of the present invention;

FIG. 16 is a diagram for explaining a relation between replacement determination of a determination section of FIG. 15 and a determination reference size;

FIG. 17 is a block diagram illustrating an embodiment of an operation memory device of FIG. 15;

FIG. 18 is a block diagram illustrating another embodiment of the operation memory device of FIG. 15;

FIG. 19 is a flowchart for explaining an operating method of the data storage apparatus of FIG. 15;

FIG. 20 is a diagram for explaining a procedure for determining a replacement of a mapping segment of FIG. 19;

FIG. 21 to FIG. 24 are diagrams illustrating the flow of data that is transmitted in each step as an operation procedure of FIG. 19 is performed;

FIG. 25 is a flowchart for explaining another operating method of the data storage apparatus of FIG. 15;

FIG. 26 to FIG. 29 are diagrams illustrating the flow of data that is transmitted in each step as an operation procedure of FIG. 25 is performed;

FIG. 30 is a diagram for explaining the case in which the unit of address mapping data, for which a translation operation and an inverse translation operation are performed, is changed; and

FIG. 31 is a diagram for explaining a data management method of the operation memory device of FIG. 15.

### DETAILED DESCRIPTION

Hereinafter, a data storage apparatus and an operating method thereof according to the present invention will be described below with reference to the accompanying drawings through exemplary embodiments. However, the present invention is not limited to the embodiments to be described herein, but may be embodied into other forms. The embodiments are provided to describe the present invention such that the technical scope of the present invention may be easily understood by those skilled in the art.

In the drawings, the embodiments of the present invention are not limited to illustrated specific forms, but are exaggerated for clarity. In this specification, specific terms are used to describe the present invention, but do not limit the scope of the present invention.

In this specification, terms such as and/or include any item among combinations of a plurality of related items or the plurality of related items. Furthermore, it will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. The terminology used herein is for the purpose of describing particular embodiments only and is not intended to be limiting of the invention. As used herein, the singular forms are intended to include the plural forms as well, unless the context clearly indicates otherwise. It will be further understood that the terms “comprise”, “comprising”, “have” and/or “having”, when used herein, specify the presence of stated features, integers, steps, operations, elements, and/or components, but do not preclude the presence or addition of one or more other features, integers, steps, operations, elements, components, and/or groups thereof.

Hereinafter, embodiments of the present invention will be described in detail with reference to the accompanying drawings.

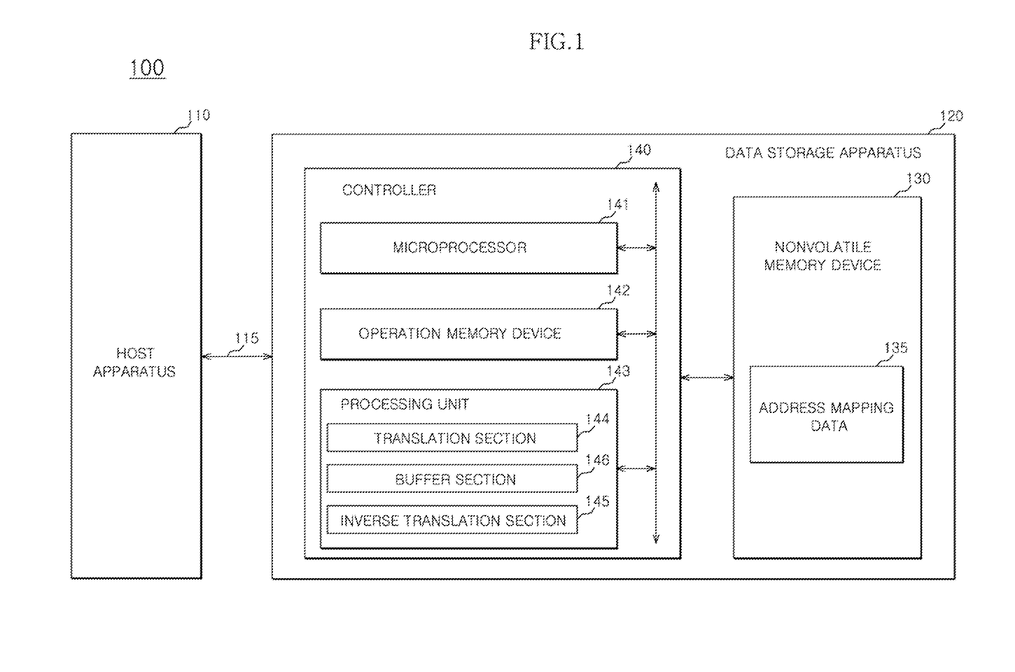

FIG. 1 is a block diagram illustrating a data processing system including a data storage apparatus according to an embodiment of the present invention.

Referring to FIG. 1, a data processing system 100 may include a host apparatus 110 and a data storage apparatus 120.

The host apparatus 110, for example, may include portable electronic apparatuses such as cellular phones, MP3 players, or laptop computers, or electronic apparatuses such as desktop computers, game machines, TVs, or projectors.

The data storage apparatus 120 may operate in response to the request of the host apparatus 110. The data storage apparatus 120 may store data that is processed by the host apparatus 110. That is, the data storage apparatus 120 may be used as a storage apparatus of the host apparatus 110.

The host apparatus 110 and the data storage apparatus 120 may be electrically coupled to each other through an interface 115. The interface 115 may include a standard interface such as Serial Advanced Technology Attachment (SATA), Parallel Advanced Technology Attachment (PATA), Universal Serial Bus (USB), Small Computer System Interface (SCSI), Serial Attached SCSI (SAS), Peripheral Component Interconnect (PCI), Peripheral Component Interconnect-Express (PCI-express), Multi-Media Card (MMC) interface, or Universal Flash Storage (UFS) interface. The host apparatus 110 and the data storage apparatus 120 may exchange a read request, a write request, or data through a mutual connection path under the system of the interface 115.

The data storage apparatus 120 may include a nonvolatile memory device 130 and a controller 140.

The nonvolatile memory device 130 may retain stored data although power is off. The nonvolatile memory device 130 may store data provided from the host apparatus 110 through a write operation. The nonvolatile memory device 130 may provide the host apparatus 110 with stored data through a read operation.

The controller 140 may include a microprocessor 141, an operation memory device 142, and a processing unit 143.

The microprocessor 141 may control the general operation of the data storage apparatus 120. The microprocessor 141 may control a write operation or a read operation for the nonvolatile memory device 130 in response to a write request or a read request from the host apparatus 110. The microprocessor 141 may drive firmware called a flash translation layer (hereinafter, referred to as FTL) in order to control the general operation of the data storage apparatus 120.

The operation memory device 142 may store the FTL that is driven by the microprocessor 141. The operation memory device 142 may store various types of data that is used by the microprocessor 141 in order to control the data storage apparatus 120. Particularly, the operation memory device 142 may store address mapping data 135 read from the nonvolatile memory device 130.

The address mapping data 135 may include a plurality of pieces of address mapping information. The address mapping information may include physical addresses corresponding to logical addresses. The logical address may be provided from the host apparatus 110 together with the read request or the write request. The physical address may indicate an actual position in the nonvolatile memory device 130 at which an operation for the read request or the write request of the host apparatus is to be performed. The address mapping information may be referred to by the microprocessor 141 that performs an address translation operation for translating a logical address (hereinafter, referred to as a request logical address) provided from the host apparatus 110 to a physical address (hereinafter, referred to as a request physical address) of the nonvolatile memory device 130.

Since the address mapping data 135 is too large to be stored in the operation memory device 142 and is very important information necessary for the driving of the data storage apparatus 120, the address mapping data 135 may be stored in the nonvolatile memory device 130. The stored address mapping data 135 may be divided into segments as a basic unit. Hereinafter, the address mapping data 135 divided in the segments is defined as mapping segments. The address mapping data 135 may be read from the nonvolatile memory device 130 by the segments, for example. The read mapping segments may be provided to the processing unit 143 before being stored in the operation memory device 142.

The processing unit 143 may include a translation section 144, an inverse translation section 145, and a buffer section 146.

The translation section 144 may perform a translation operation on the mapping segment, i.e. a normal mapping segment, to generate a translation mapping segment. That is, the translation section 144 may translate the normal mapping segment to the translation mapping segment. The translation section 144 may translate the normal mapping segment to the translation mapping segment such that a size of the translation mapping segment is smaller than that of the normal mapping segment.

For example, when the normal mapping segment includes sequential mapping data including sequential physical addresses corresponding to sequential logical addresses and random mapping data other than the sequential mapping data, the translation section 144 may translate the normal mapping segment to the translation mapping segment so that respective start addresses and lengths of the sequential mapping data and the random mapping data are included.

The inverse translation section 145 may perform an inverse translation operation on the translation mapping segment in order to generate the normal mapping segment. That is, the inverse translation section 145 may inversely translate the translation mapping segment to the normal mapping segment. The inverse translation section 145 may generate the normal mapping segment with reference to the start address and the length included in the translation mapping segment so that one physical address corresponds to one logical address or sequential physical addresses correspond to sequential logical addresses, respectively. For example, when new address mapping information is updated on the normal mapping segment, the inverse translation section 145 may perform the inverse translation operation. In another example, the inverse translation section 145 may perform the inverse translation operation so that an inversely translated normal mapping segment is backed up.

The buffer section 146 may temporally store the normal mapping segment or the translation mapping segment in order to allow the translation section 144 or the inverse translation section 145 to perform the translation operation or the inverse translation operation. The buffer section 146 may include areas, which correspond to the translation section 144 and the inverse translation section 145, respectively, that is, areas to be used by the translation section 144 and the inverse translation section 145, respectively. FIG. 1 illustrates the case in which the buffer section 146 is included in the processing unit 143. However, the buffer section 146 may be provided outside of the processing unit 143.

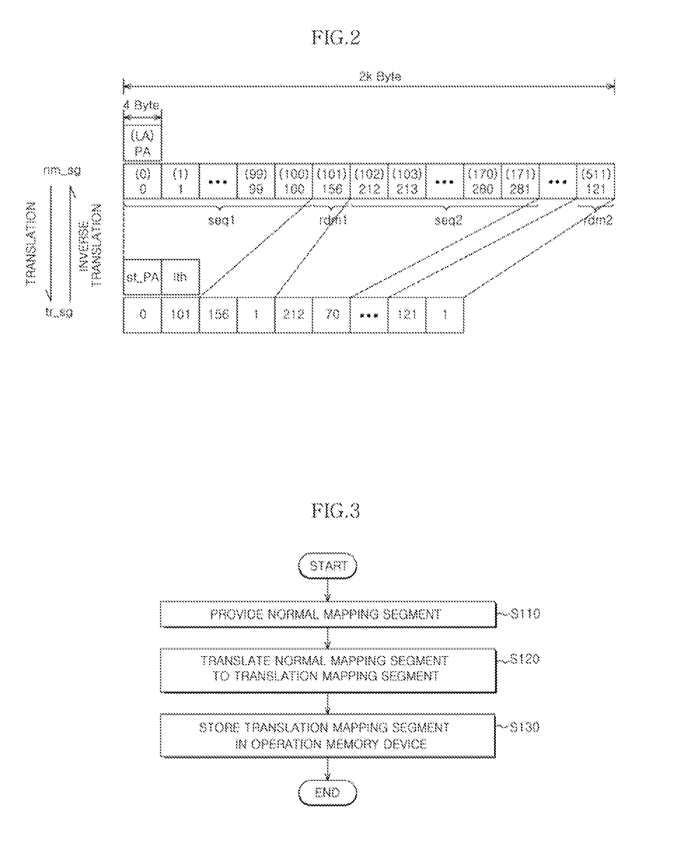

FIG. 2 is a diagram for explaining a method in which the translation section 144 and the inverse translation section 145 of FIG. 1 perform a translation operation and an inverse translation operation, respectively.

In the following detailed description, it is described as an example that one normal mapping segment nm_sg is 2K bytes and one address mapping information is 4 bytes. The normal mapping segment nm_sg may include 512 pieces of address mapping information, that is, physical addresses PA corresponding to logical addresses LA=0 to LA=511.

When the normal mapping segment nm_sg is arranged as illustrated in FIG. 2, the normal mapping segment nm_sg may include sequential mapping data seq1 and seq2 and random mapping data rdm1 and rdm2. The sequential mapping data seq1 and seq2 may include sequential physical addresses PA corresponding to sequential logical addresses LA. The sequential mapping data seq1 and seq2 may indicate a period in which two or more physical addresses PA have been sequentially allocated to sequential logical addresses LA. Data, other than the sequential mapping data, may be the random mapping data rdm1 and rdm2. The random mapping data rdm1 and rdm2 is not the sequential mapping data, and may indicate a period in which two or more physical addresses PA have not been sequentially allocated.

Referring to FIG. 2, for example, a period from a physical address PA=0 corresponding to a logical address LA=0 to a physical address PA=100 corresponding to a logical address LA=100 indicates first sequential mapping data seq1 because two or more physical addresses PA=0 to PA=100 have been sequentially allocated to the sequential logical addresses LA=0 to LA=100. For example, a physical address PA=156 corresponding to a logical address LA=101 indicates first random mapping data rdm1 because two or more physical addresses PA have not been sequentially allocated to sequential logical addresses LA. For example, a period from a physical address PA=212 corresponding to a logical address LA=102 to a physical address PA=281 corresponding to a logical address LA=171 indicates second sequential mapping data seq2 because the two or more physical addresses PA=212 to PA=281 have been sequentially allocated to the sequential logical addresses LA=102 to LA=171. For example, a physical address PA=121 corresponding to a logical address LA=511 indicates second random mapping data rdm2 because two or more physical addresses PA have not been sequentially allocated to sequential logical addresses LA.

The translation section (144 of FIG. 1) may perform a translation operation on the normal mapping segment nm_sg including the sequential mapping data and the random mapping data to generate a translation mapping segment tr_sg so that a start address st_PA and a length lth of the sequential mapping data and the random mapping data are included in the translation mapping segment tr_sg. The start address st_PA indicates a physical address PA that has been first allocated in the sequential mapping data and the random mapping data. The length lth indicates the number of physical addresses PA included in the sequential mapping data and the random mapping data. That is, the length lth indicates the number of physical addresses PA allocated from the start address st_PA, corresponding to sequential logical addresses LA. For example, in the first sequential mapping data seq1, the start address st_PA is 0 and the length lth is 101. The translation section 144 may perform a translation operation so that the translation mapping segment tr_sg includes the start address st_PA=0 and the length lth=101, instead of the first sequential mapping data seq1 of the normal mapping segment nm_sg. In such a manner, the translation section 144 may perform a translation operation such that the translation mapping segment tr_sg includes the start address st_PA=156 and the length lth=1, instead of the first random mapping data rdm1 of the normal mapping segment nm_sg. Furthermore, the translation section 144 may perform a translation operation so that the translation mapping segment tr_sg includes the start address st_PA=212 and the length lth=70, instead of the second sequential mapping data seq2 of the normal mapping segment nm_sg. Furthermore, the translation section 144 may perform a translation operation so that the translation mapping segment tr_sg includes the start address st_PA=121 and the length lth=1, instead of the second random mapping data rdm2 of the normal mapping segment nm_sg.

The inverse translation section (145 of FIG. 1) may generate the normal mapping segment nm_sg with reference to the start address st_PA and the length lth included in the translation mapping segment tr_sg so that one physical address PA corresponds to one logical address LA or sequential physical addresses PA correspond to sequential logical addresses LA, respectively. In detail, the inverse translation section 145 may inversely translate the translation mapping segment tr_sg to the normal mapping segment nm_sg so that the physical address PA is allocated corresponding to the sequential logical addresses LA from the start address st_PA by the length lth.

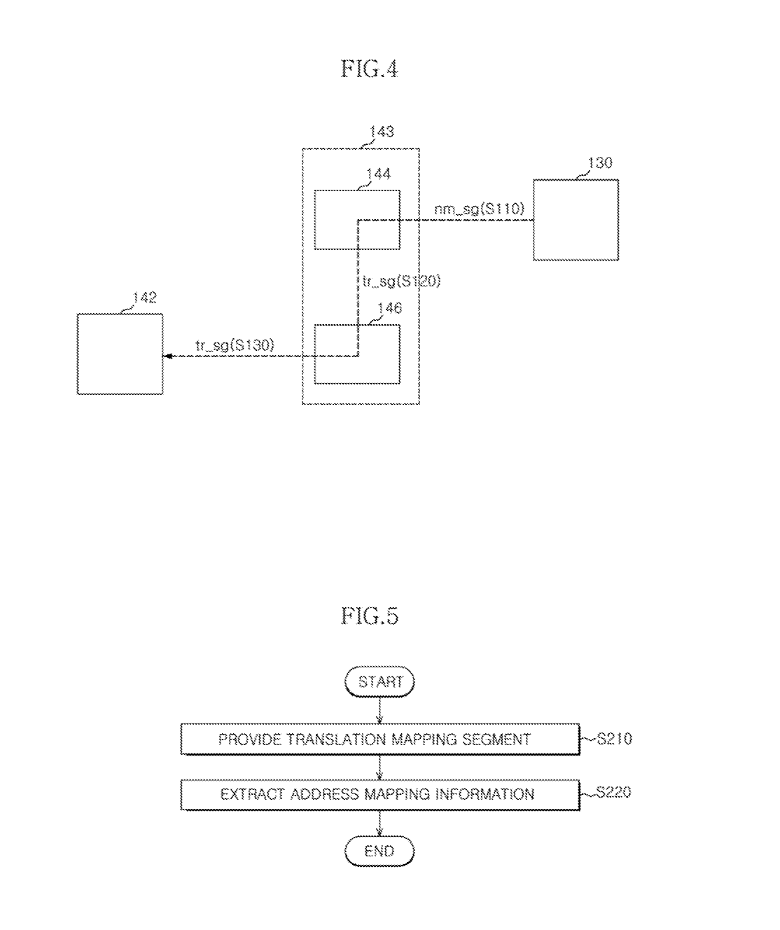

FIG. 3 is a flowchart for explaining a first operating method of the data storage apparatus 120 of FIG. 1. FIG. 3 illustrates an operating method when the normal mapping segment is provided from the nonvolatile memory device (130 of FIG. 1).

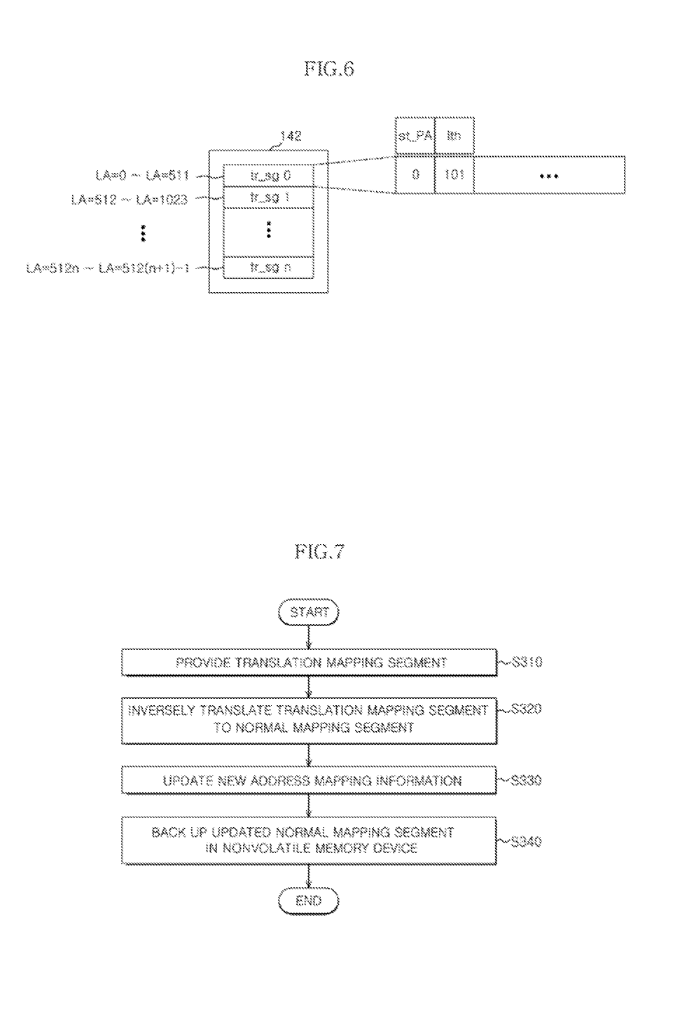

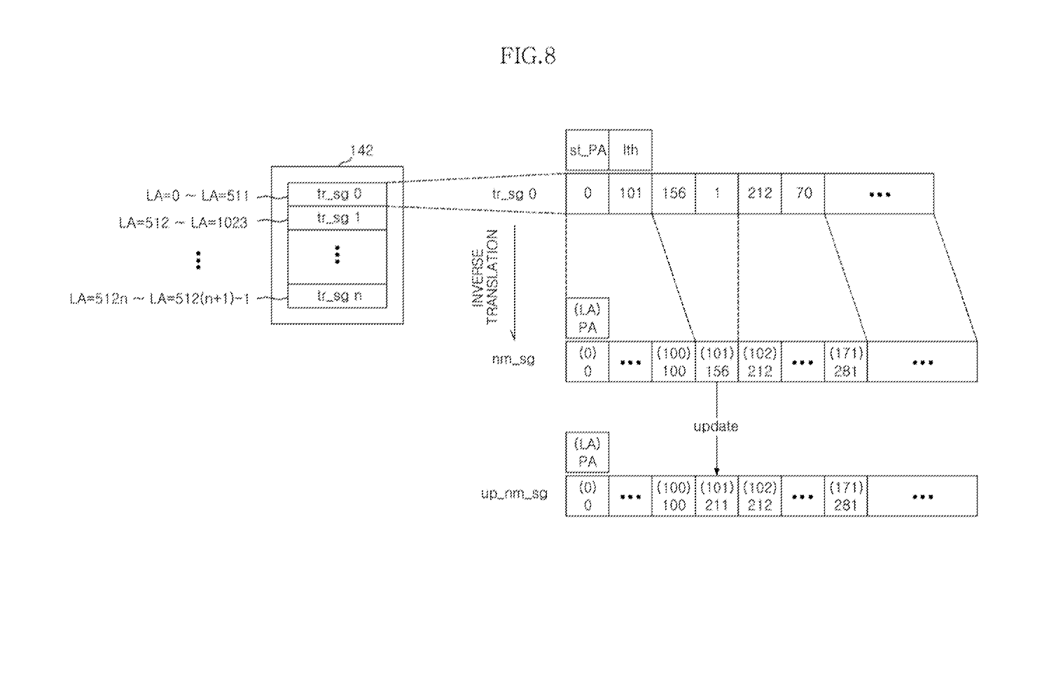

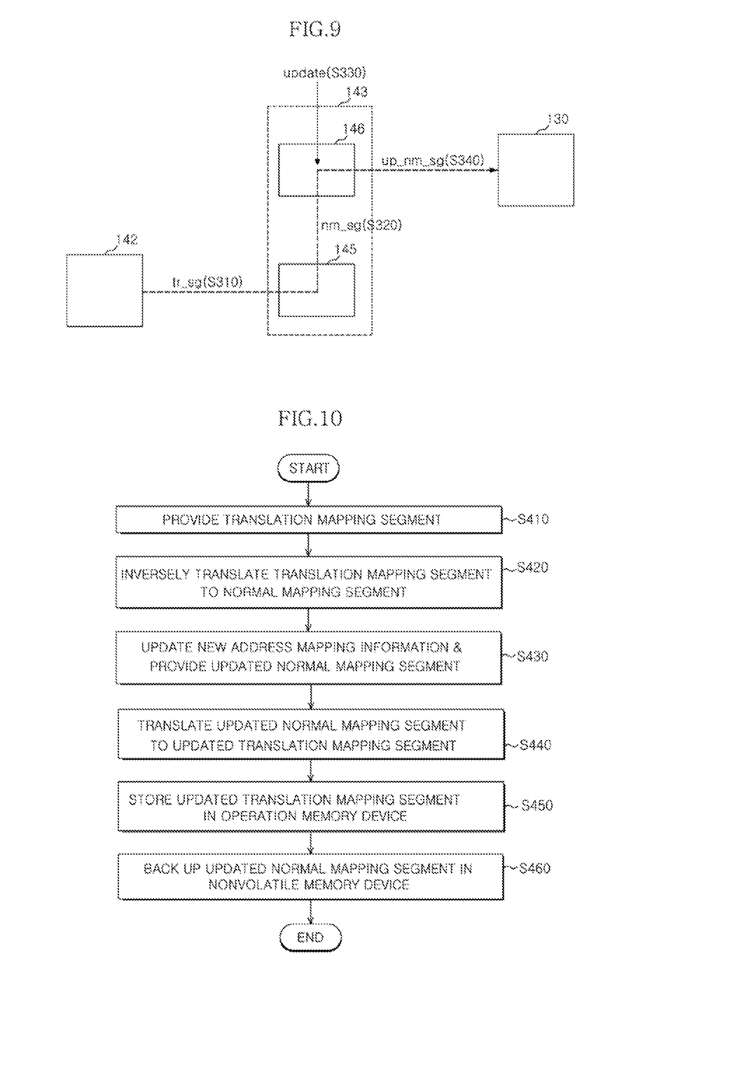

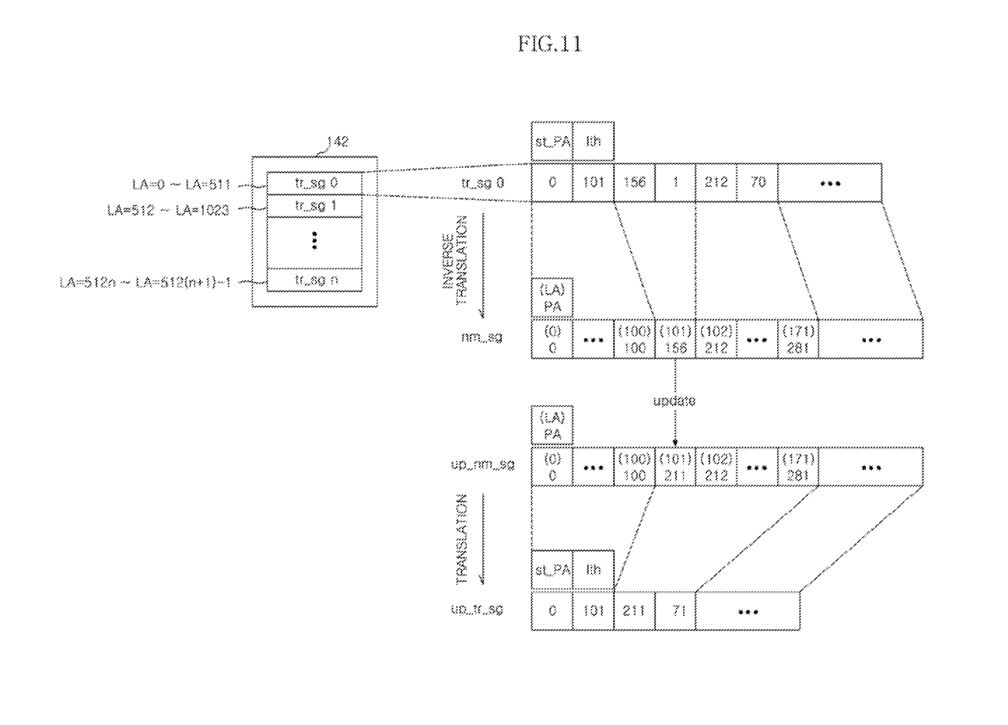

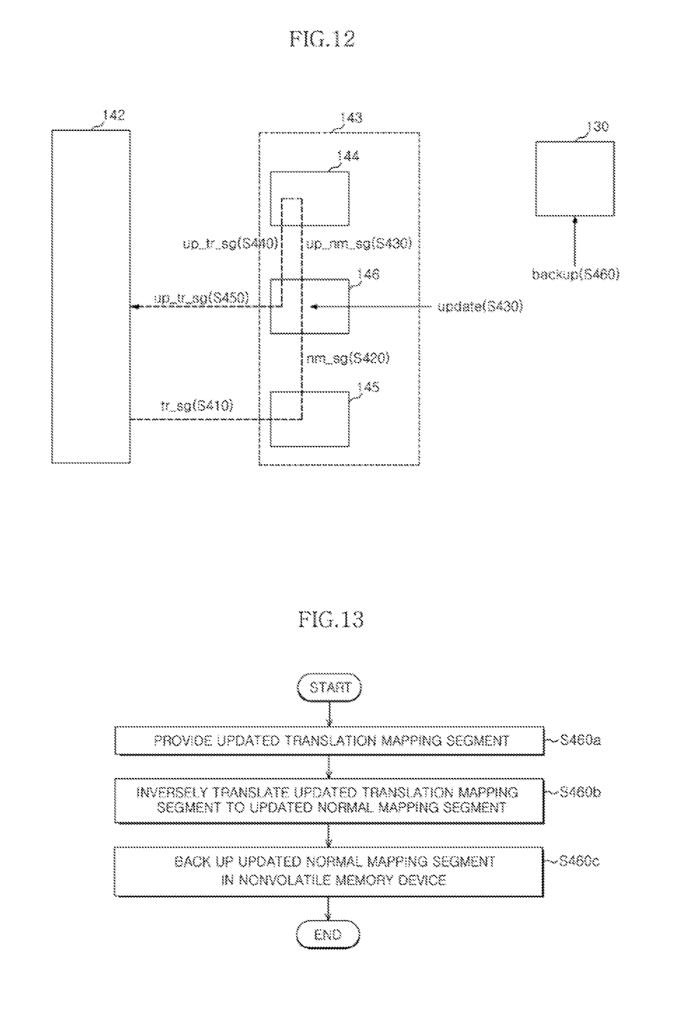

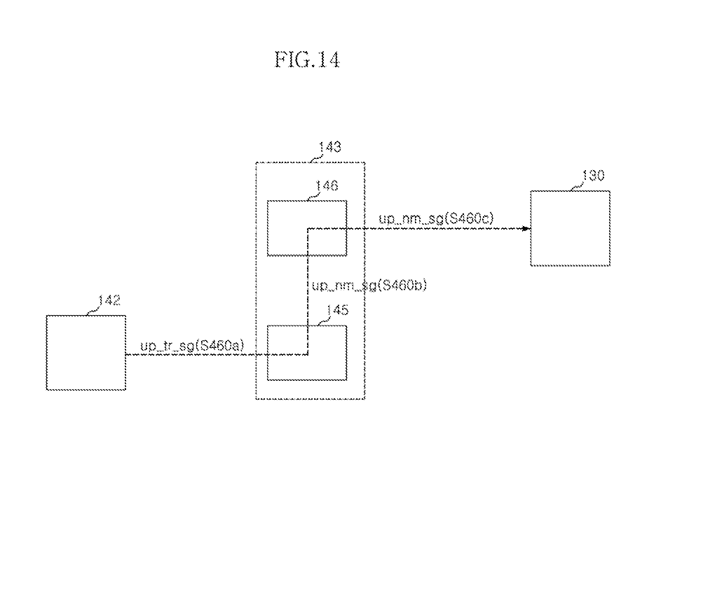

FIG. 4 is a diagram illustrating the flow of data that is transmitted in each step as the operation procedure of FIG. 3 is performed. In FIG. 4, the schematic flow of the normal mapping segment nm_sg and the translation mapping segment tr_sg is indicated by dotted lines.

Hereinafter, with reference to FIG. 3 and FIG. 4, the operating method of the data storage apparatus (120 of FIG. 1) will be described.

In step S110, the normal mapping segment nm_sg stored in the nonvolatile memory device 130 may be provided to the translation section 144.

In step S120, the translation section 144 may translate the provided normal mapping segment nm_sg to the translation mapping segment tr_sg. The buffer section 146 may temporally store the generated translation mapping segment tr_sg.

In step S130, the translation mapping segment tr_sg may be stored in the operation memory device 142.

FIG. 5 is a flowchart for explaining a second operating method of the data storage apparatus 120 of FIG. 1. FIG. 5 illustrates the process in which necessary address mapping information is extracted from the translation mapping segment tr_sg stored in the operation memory device (142 of FIG. 1).

FIG. 6 is a diagram for explaining the operating method according to FIG. 5.

Hereinafter, with reference to FIG. 5 and FIG. 6, the operating method of the data storage apparatus (120 of FIG. 1) will be described.

In step S210, the translation mapping segment tr_sg stored in the operation memory device 142 may be provided. The provided translation mapping segment tr_sg indicates a specific translation mapping segment tr_sg for necessary address mapping information.

Referring to FIG. 6, translation mapping segments tr_sg 0 to tr_sg n may be stored in the operation memory device 142. For example, the 0^{th} translation mapping segment tr_sg 0 relates to address mapping information from the logical address LA=0 to the logical address LA=511, and the first translation mapping segment tr_sg 1 relates to address mapping information from a logical address LA=512 to a logical address LA=1023. For example, when a request logical address LA provided from the host apparatus 110 is 49, the 0^{th} translation mapping segment tr_sg 0 may be provided.

In step S220, the microprocessor (141 of FIG. 1) may extract the necessary address mapping information from the provided translation mapping segment tr_sg. The microprocessor 141 may extract the necessary address mapping information, i.e., a request physical address corresponding to a request logical address, through an arithmetic operation. A logical address corresponding to a certain start address st_PA of the translation mapping segment tr_sg is defined as a start logical address. For example, in FIG. 6, a start logical address LA corresponding to the start address st_PA=0 is 0.

The request physical address, for example, may be calculated as follows.

When a \textcircled{1} equation (k=(request logical address)−(start logical address)) is satisfied and a \textcircled{2} equation (0≦k<length) is satisfied, a \textcircled{3} equation (request physical address=(start address)+k) is satisfied.

For the start address st_PA=0 and the length lth=101 stored in the 0^{th} translation mapping segment tr_sg 0, a request physical address corresponding to a request logical address LA=49 may be calculated as follows.

Since k=49−0=49 according to the \textcircled{1} equation and 0≦49<101 according to the \textcircled{2} equation, the request physical address=0+49=49 according to the \textcircled{3} equation.

FIG. 7 is a flowchart for explaining a third operating method of the data storage apparatus 120 of FIG. 1. FIG. 7 illustrates an operating method when the normal mapping segment is updated in order to reflect new address mapping information.

FIG. 8 is a diagram for explaining the operating method according to FIG. 7.

FIG. 9 is a diagram illustrating the flow of data that is transmitted in each step as the operation procedure of FIG. 7 is performed. In FIG. 9, the schematic flow of the translation mapping segment tr_sg and the normal mapping segment nm_sg is indicated by dotted lines.

Hereinafter, with reference to FIG. 7 to FIG. 9, the operating method of the data storage apparatus (120 of FIG. 1) will be described.

In step S310, the translation mapping segment tr_sg stored in the operation memory device 142 may be provided to the inverse translation section 145. The provided translation mapping segment tr_sg is a specific translation mapping segment tr_sg to be updated so that new address mapping information is reflected.

Referring to FIG. 8, translation mapping segments tr_sg 0 to tr_sg n may be stored in the operation memory device 142. For example, when a physical address PA=211 is allocated to a logical address LA=101 as new address mapping information, the 0^{th} translation mapping segment tr_sg 0 may be provided to the inverse translation section 145.

In step S320, the inverse translation section 145 may inversely translate the provided translation mapping segment tr_sg to the normal mapping segment nm_sg. The buffer section 146 may temporally store the generated normal mapping segment nm_sg.

In step S330, the normal mapping segment nm_sg may be updated so that the new address mapping information is reflected. The update may be performed by the microprocessor (141 of FIG. 1). For example, referring to FIG. 8, a physical address corresponding to the logical address LA=101 may be updated from existing PA=156 to new PA=211.

In step S340, the updated normal mapping segment up_nm_sg may be backed up in the nonvolatile memory device 130. The updated normal mapping segment up_nm_sg may be backed up immediately after being generated.

FIG. 10 is a flowchart for explaining a fourth operating method of the data storage apparatus 120 of FIG. 1. FIG. 10 illustrates another operating method when the normal mapping segment is updated in order to reflect new address mapping information.

FIG. 11 is a diagram for explaining the operating method according to FIG. 10.

FIG. 12 is a diagram illustrating the flow of data that is transmitted in each step as the operation procedure of FIG. 10 is performed. In FIG. 12, the schematic flow of the translation mapping segment tr_sg and the normal mapping segment nm_sg is indicated by dotted lines.

Hereinafter, with reference to FIG. 10 to FIG. 12, the operating method of the data storage apparatus (120 of FIG. 1) will be described.

In step S410, the translation mapping segment tr_sg stored in the operation memory device 142 may be provided to the inverse translation section 145. The provided translation mapping segment tr_sg is a specific translation mapping segment tr_sg to be updated such that new address mapping information is reflected.

Referring to FIG. 11, translation mapping segments tr_sg 0 to tr_sg n may be stored in the operation memory device 142. For example, when a physical address PA=211 is allocated to a logical address LA=101 as new address mapping information, the 0^{th} translation mapping segment tr_sg 0 may be provided to the inverse translation section 145.

In step S420, the inverse translation section 145 may inversely translate the provided translation mapping segment tr_sg to the normal mapping segment nm_sg. The buffer section 146 may temporally store the generated normal mapping segment nm_sg.

In step S430, the normal mapping segment nm_sg may be updated so that the new address mapping information is reflected. The update may be performed by the microprocessor (141 of FIG. 1). For example, referring to FIG. 11, a physical address corresponding to the logical address LA=101 may be updated from existing PA=156 to new PA=211. The updated normal mapping segment up_nm_sg may be provided to the translation section 144.

In step S440, the translation section 144 may translate the updated normal mapping segment up_nm_sg to an updated translation mapping segment up_tr_sg. Referring to FIG. 11, the updated translation mapping segment up_tr_sg, in which the new address mapping information has been reflected, may be generated.

In step S450, the updated translation mapping segment up_tr_sg may be stored in the operation memory device 142. That is, the updated normal mapping segment up_nm_sg may not be immediately backed up in the nonvolatile memory device 130 after being generated. It may be translated to the updated translation mapping segment up_tr_sg to be stored in the operation memory device 142.

In step S460, backup for the nonvolatile memory device 130 may be performed. The backup may be performed after the updated translation mapping segment up_tr_sg is stored in the operation memory device 142 and a predetermined time lapses.

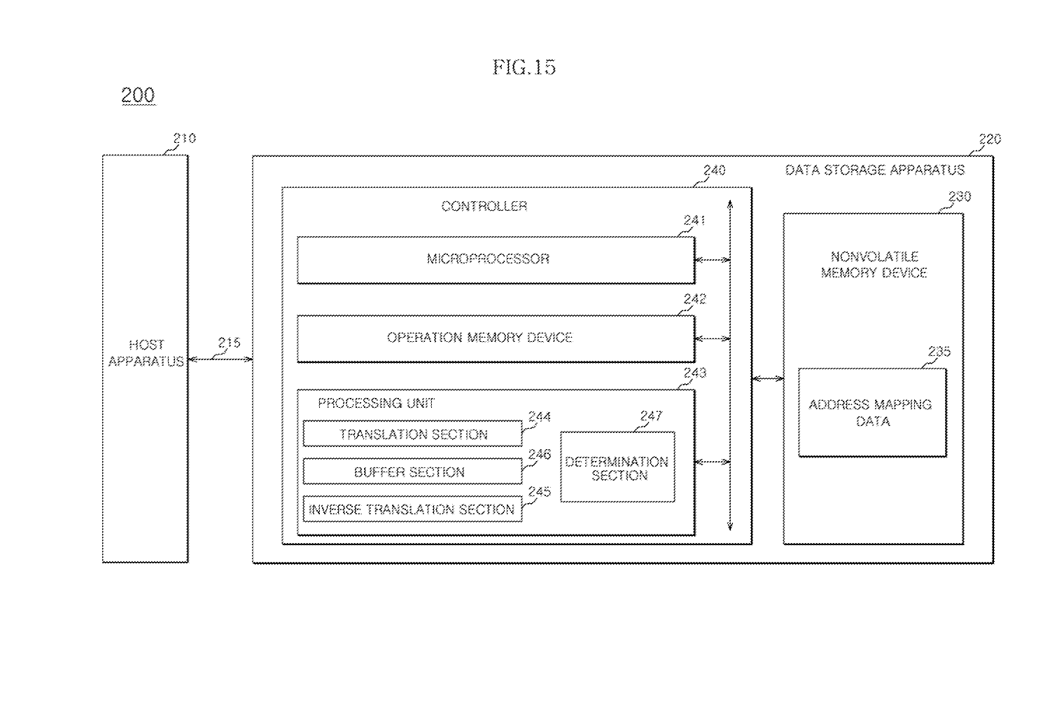

FIG. 13 is a flowchart for explaining a method in which the data storage apparatus 120 performs backup. FIG. 13 illustrates a detailed flowchart for step S460 of FIG. 10.

FIG. 14 is a diagram illustrating the flow of data that is transmitted in each step as the operation procedure of FIG. 13 is performed. In FIG. 14, the schematic flow of the updated normal mapping segment up_nm_sg and the updated translation mapping segment up_tr_sg is indicated by dotted lines.

Hereinafter, with reference to FIG. 13 and FIG. 14, the method in which the data storage apparatus performs backup will be described.

In step S460a, the updated translation mapping segment up_tr_sg stored in the operation memory device 142 may be provided to the inverse translation section 145. In step S460b, the inverse translation section 145 may inversely translate the updated translation mapping segment up_tr_sg to the updated normal mapping segment up_nm_sg. The buffer section 146 may temporally store the generated updated normal mapping segment up_nm_sg. In step S460c, the updated normal mapping segment up_nm_sg may be backed up in the nonvolatile memory device 130.

In the translation operation of the translation section (144 of FIG. 1), the normal mapping segment is compressed, so that the translation mapping segment is generated. For example, a start address and a length included in the translation mapping segment may be 4 bytes and 1 byte, respectively. In such a case, even when certain sequential mapping data included in the normal mapping segment includes only two pieces of address mapping information, corresponding sequential mapping data of 8 bytes (=4 bytes×2) may be compressed to 5 bytes (=4 bytes+1 byte) through the translation operation. As the sequential length of the sequential mapping data is long, a compression effect is large. For example, since the first sequential mapping data seq1 of 404 bytes (=4 bytes×101) included in the normal mapping segment nm_sg of FIG. 2 may be compressed to 5 bytes (=4 bytes+1 byte) though the translation operation, a compression effect is larger than that in the previous case.

The translation section 144 may simultaneously perform the translation operation for sequential mapping data and random mapping data included in the normal mapping segment. When the translation section 144 translates the random mapping data, the size of the random mapping data after the translation may be larger than that before the translation. However, it may also be covered by a compression effect of the sequential mapping data with a long sequential length in the normal mapping segment. Otherwise, for example, if all normal mapping segments include only random mapping data, a compression effect based on the translation operation may not be generated. Hereinafter, a data storage apparatus according to another embodiment of the present invention may store the translation mapping segment in consideration of the compression effect based on the translation operation.

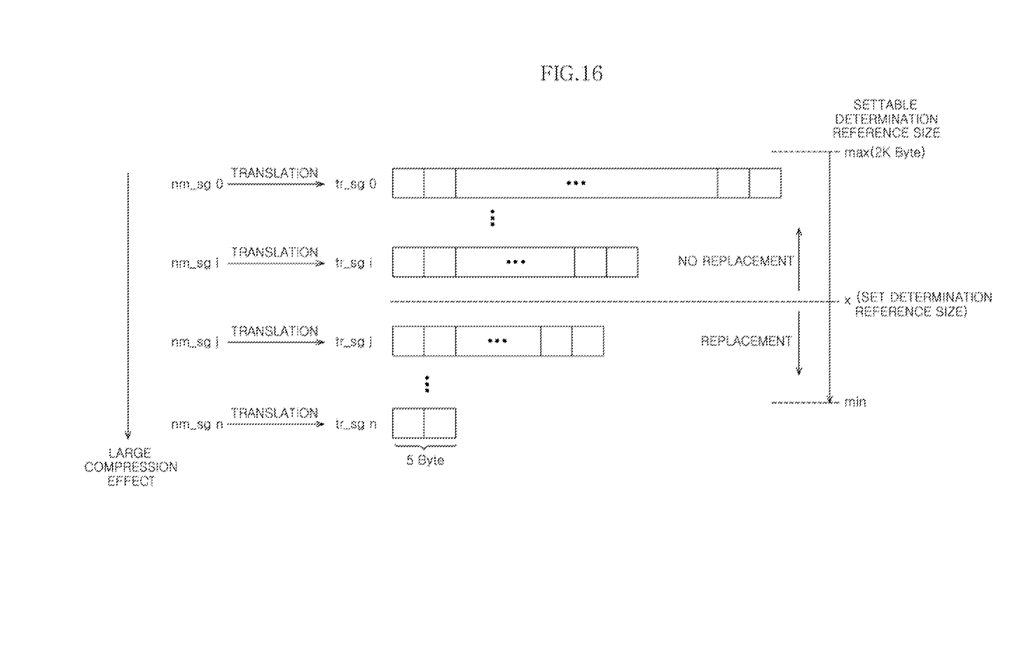

FIG. 15 is a block diagram illustrating a data processing system including a data storage apparatus according to another embodiment of the present invention.

A data processing system 200 may include a host apparatus 210 and a data storage apparatus 220. The data storage apparatus 220 may include a nonvolatile memory device 230 and a controller 240. The controller 240 may include a microprocessor 241, an operation memory device 242, and a processing unit 243. The processing unit 243 may include a translation section 244, an inverse translation section 245, a buffer section 246, and a determination section 247.

The determination section 247 may determine whether or not to replace the normal mapping segment with the translation mapping segment. The determination section 247 may determine whether or not to perform the replacement based on the size of the translation mapping segment. To this end, the determination section 247 may calculate the size of the translation mapping segment. The determination section 247 may compare the size of the translation mapping segment with a preset determination reference size. For example, when the size of the translation mapping segment is smaller than the determination reference size, the determination section 247 may determine to replace the normal mapping segment with the translation mapping segment. For example, when the size of the translation mapping segment is equal to or greater than the determination reference size, the determination section 247 may determine not to replace the normal mapping segment with the translation mapping segment. The determination reference size may be set to be equal to or less than the size of the normal mapping segment.

The translation mapping segment or the normal mapping segment may be stored in the operation memory device 242 based on the determination of the determination section 247. That is, when the determination section 247 determines to replace the normal mapping segment with the translation mapping segment, the translation mapping segment may be stored in the operation memory device 242. When the determination section 247 determines not to replace the normal mapping segment with the translation mapping segment, the normal mapping segment may be stored in the operation memory device 242.

FIG. 16 is a diagram for explaining a relationship between replacement determination of the determination section 247 of FIG. 15 and the determination reference size. Referring to FIG. 16, the sizes of translation mapping segments tr_sg 0 to tr_sg n are smaller than those of respective normal mapping segments nm_sg 0 to nm_sg n. The sizes of the translation mapping segments tr_sg 0 to tr_sg n decreases in the order listed. That is, a compression effect increases in the order of the translation mapping segments tr_sg 0 to tr_sg n.

Since the size of the translation mapping segment tr_sg is to be smaller than that of the normal mapping segment nm_sg, the determination reference size may be set to be equal to or less than the size of the normal mapping segment nm_sg. The determination section (247 of FIG. 15) may differently determine a replacement with a specific translation mapping segment tr_sg depending on a setting value of the determination reference size. For example, when the determination reference size is set as an x value, the determination section 247 may determine a replacement with translation mapping segments tr_sg j to tr_sg n and may not determine a replacement with translation mapping segments tr_sg 0 to tr_sg i.

In another example, when the determination reference size is set to be substantially equal to the size (that is, 2K bytes) of the normal mapping segment nm_sg, and if the size of the translation mapping segment tr_sg is smaller than that of the normal mapping segment nm_sg, the determination section 247 may determine to replace the normal mapping segment with the translation mapping segment regardless of a compression effect. Consequently, the determination section 247 may determine a replacement with the translation mapping segments tr_sg 0 to tr_sg n.

That is, the determination section 247 may determine a replacement of the mapping segments only when a larger compression effect is generated as the preset determination reference size is small.

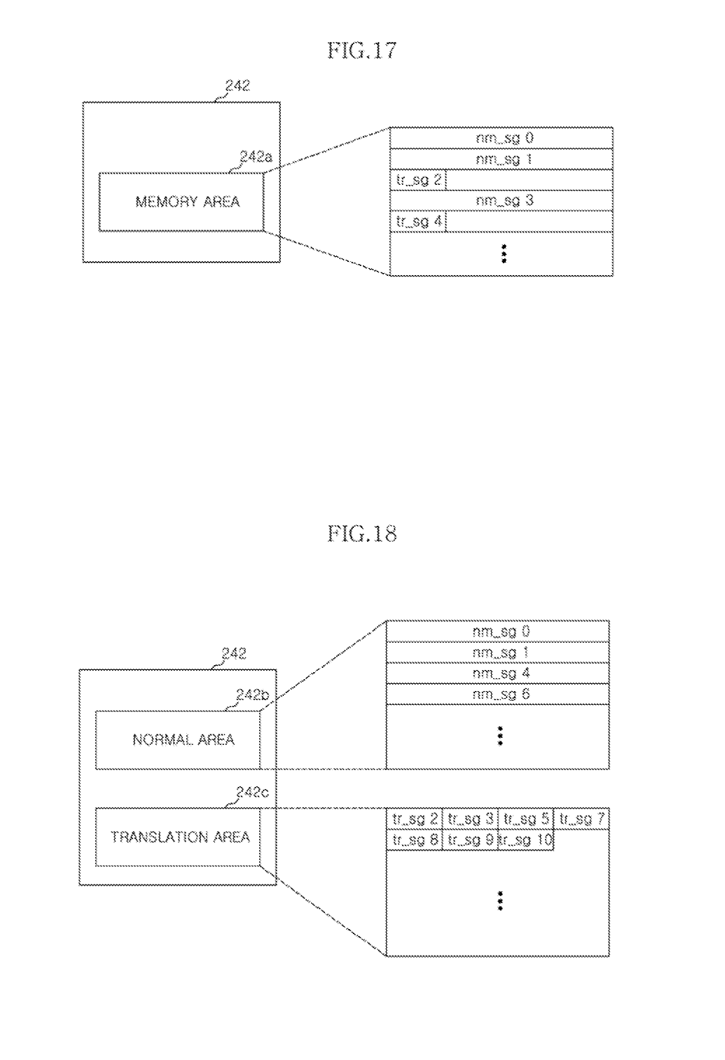

FIG. 17 is a block diagram illustrating an embodiment of the operation memory device 242 of FIG. 15.

Referring to FIG. 17, the operation memory device 242 may include a memory area 242a. Since the normal mapping segment nm_sg or the translation mapping segment tr_sg may be stored in the memory area 242a depending on the determination of the determination section (247 of FIG. 15) regarding a replacement of mapping segments, normal mapping segments and translation mapping segments, which have sizes different from each other, may be stored in the memory area 242a. The memory area 242a may be arranged through a management method which will be described later.

FIG. 18 is a block diagram illustrating another embodiment of the operation memory device 242 of FIG. 15.

Referring to FIG. 18, the operation memory device 242 may include two memory areas, that is, a normal area 242b and a translation area 242c. The normal mapping segment nm_sg may be stored in the normal area 242b. The translation mapping segment tr_sg may be stored in the translation area 242c. When the normal mapping segment nm_sg and the translation mapping segment tr_sg, which have sizes different from each other, are separately stored in the two memory areas 242b and 242c, they may be managed more efficiently as compared with being stored together with each other. In FIG. 18, the normal area 242b and the translation area 242c are included in one operation memory device. However, the normal area 242b and the translation area 242c may be included in operation memory devices different from each other, respectively.

Detailed configuration and operating method of other elements or units illustrated in FIG. 15 may be similar to the configuration and operating method described through FIG. 1 and FIG. 2. Accordingly, a detailed description thereof will be omitted.

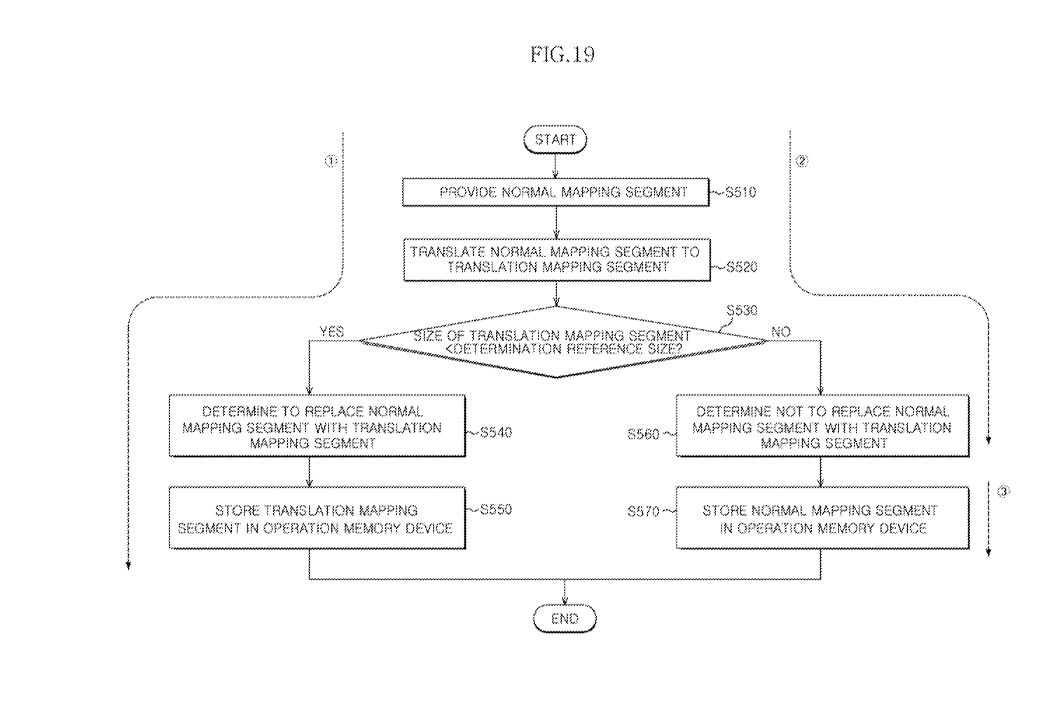

FIG. 19 is a flowchart for explaining an operating method of the data storage apparatus 220 of FIG. 15. FIG. 19 illustrates a procedure in which the translation section (244 of FIG. 15) performs a translation operation on a provided normal mapping segment, and the determination section (247 of FIG. 15) determines a replacement with a generated translation mapping segment.

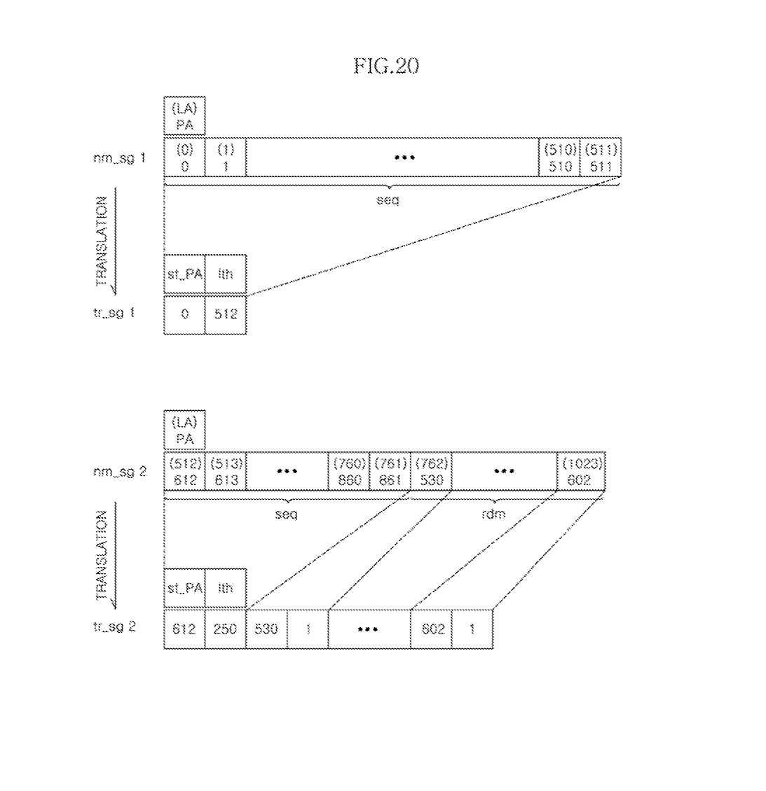

FIG. 20 is a diagram for explaining a procedure for determining a replacement of the mapping segment of FIG. 19.

Hereinafter, with reference to FIG. 15, FIG. 19, and FIG. 20, the operating method of the data storage apparatus 220 of FIG. 15 will be described.

In step S510, a normal mapping segment may be provided to the translation section 244.

In step S520, the translation section 244 may translate the provided normal mapping segment to a translation mapping segment.

In step S530, the determination section 247 may compare the size of the translation mapping segment with the determination reference size. The determination section 247 may determine whether the size of the translation mapping segment is smaller than the determination reference size. When the size of the translation mapping segment is smaller than the determination reference size (Yes), the procedure may proceed to step S540. When the size of the translation mapping segment is equal to or greater than the determination reference size (No), the procedure may proceed to step S560.

For example, referring to FIG. 20, when the translation section 244 translates the first normal mapping segment nm_sg 1 to the first translation mapping segment tr_sg 1, the first normal mapping segment nm_sg 1 may be compressed from 2K bytes (=4 bytes×512) before the translation to 5 bytes (=4 bytes+1 byte) after the translation. When the determination reference size is set to 512 bytes, since the size 5 bytes of the first translation mapping segment tr_sg 1 is smaller than the determination reference size 512 bytes, the procedure may proceed to step S540.

In another example, referring to FIG. 20, when the translation section 244 translates the second normal mapping segment nm_sg 2 to the second translation mapping segment tr_sg 2, the second normal mapping segment nm_sg 2 may be compressed from 2K bytes (=4 bytes×512) before the translation to 1315 bytes (=(4 bytes+1 byte)×263) after the translation. When the determination reference size is set to 512 bytes, since the size 1315 bytes of the second translation mapping segment tr_sg 2 is greater than the determination reference size 512 bytes, the procedure may proceed to step S560.

Referring to again FIG. 19, in step S540, the determination section 247 may determine to replace the normal mapping segment with the translation mapping segment.

In step S550, the translation mapping segment may be stored in the operation memory device 242. For example, the first translation mapping segment tr_sg 1 may be stored in the operation memory device 242.

In step S560, the determination section 247 may determine not to replace the normal mapping segment with the translation mapping segment.

In step S570, the normal mapping segment may be stored in the operation memory device 242. For example, the second normal mapping segment nm_sg 2 may be stored in the operation memory device 242.

FIG. 21 to FIG. 24 are diagrams illustrating the flow of data that is transmitted in each step as the operation procedure of FIG. 19 is performed. In FIG. 21 to FIG. 24, the schematic flow of the translation mapping segment tr_sg and the normal mapping segment nm_sg is indicated by dotted lines.

FIG. 21 illustrates the flow \textcircled{1} of data (the procedure \textcircled{1} of FIG. 19) in which the normal mapping segment nm_sg stored in the nonvolatile memory device 230 is provided to the translation section 244 in step S510 and the determination section 247 determines to replace the normal mapping segment nm_sg with the translation mapping segment tr_sg in step S540.

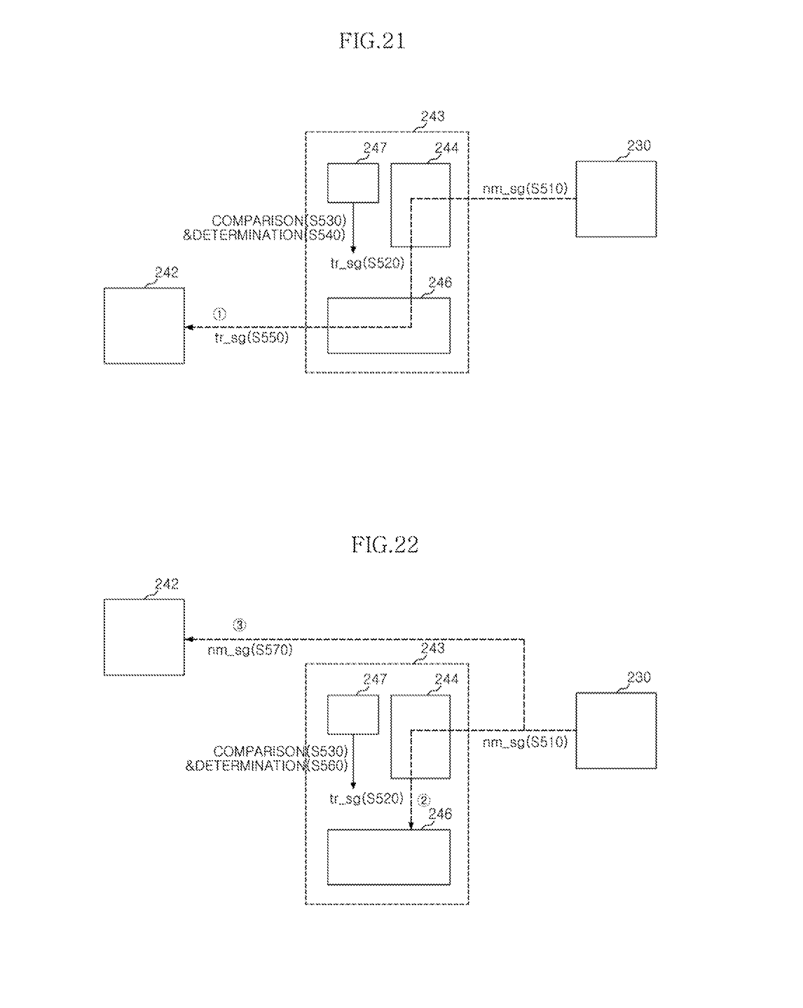

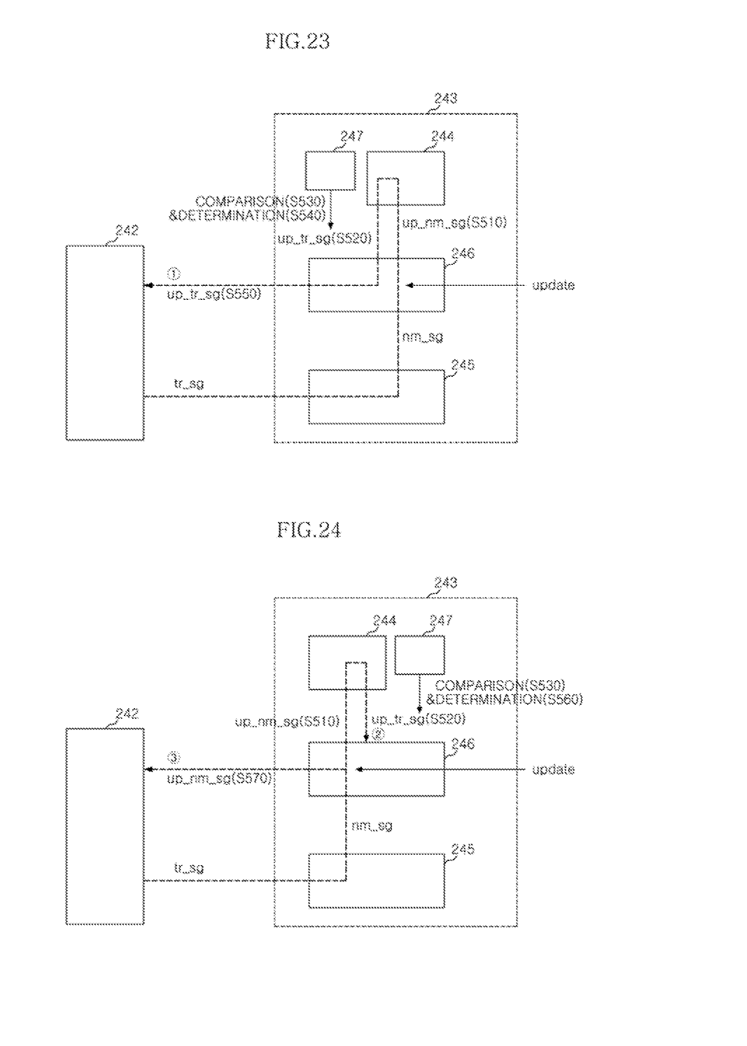

FIG. 22 illustrates the flows \textcircled{2} and \textcircled{3} of data (the procedures \textcircled{2} and \textcircled{3} of FIG. 19) in which the normal mapping segment nm_sg stored in the nonvolatile memory device 230 is provided to the translation section 244 in step S510 and the determination section 247 determines not to replace the normal mapping segment nm_sg with the translation mapping segment tr_sg in step S560.

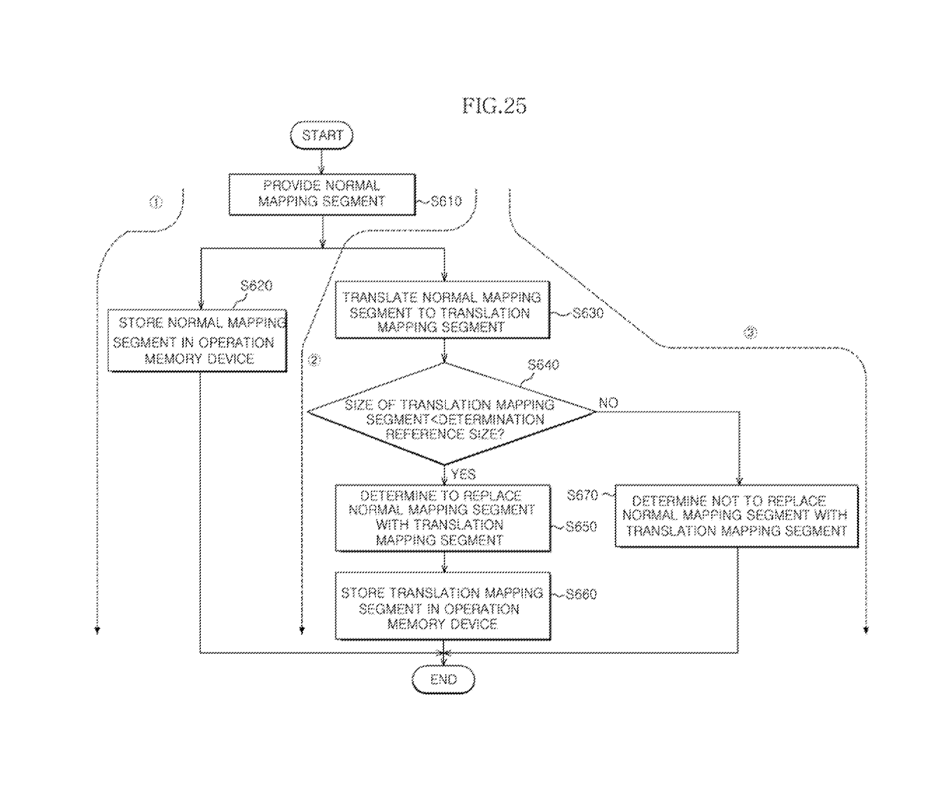

FIG. 23 illustrates the flow \textcircled{1} of data (the procedure \textcircled{1} of FIG. 19) in which the updated normal mapping segment up_nm_sg is provided to the translation section 244 in step S510 and the determination section 247 determines to replace the updated normal mapping segment up_nm_sg with the updated translation mapping segment up_tr_sg in step S540.

FIG. 24 illustrates the flows \textcircled{2} and \textcircled{3} of data (the procedures \textcircled{2} and \textcircled{3} of FIG. 19) in which the updated normal mapping segment up_nm_sg is provided to the translation section 244 in step S510 and the determination section 247 determines not to replace the updated normal mapping segment up_nm_sg with the updated translation mapping segment up_tr_sg in step S560.

Referring to FIG. 23 and FIG. 24, for example, the translation mapping segment tr_sg provided from the operation memory device 242 may be inversely translated and updated in order to be provided as the updated normal mapping segment up_nm_sg.

FIG. 25 is a flowchart for explaining another operating method of the data storage apparatus 220 of FIG. 15.

The operating method of the data storage apparatus (220 of FIG. 15), which has been described with reference to FIG. 19, includes step S550, in which the translation mapping segment is stored in the operation memory device (242 of FIG. 15), or step S570, in which the normal mapping segment is stored in the operation memory device 242, based on the determination of the determination section (247 of FIG. 15) regarding a replacement of the mapping segment.

The data storage apparatus 220, which will be described with reference to FIG. 25, may preferentially store the normal mapping segment in the operation memory device 242 regardless of the determination of the determination section 247 regarding a replacement of the mapping segment. The translation section 244 may perform a translation operation for translating the normal mapping element to the translation mapping segment. The determination section 247 may determine whether to replace the normal mapping element with the translation mapping segment based on the size of the translation mapping segment. The operation memory device 242 may store the normal mapping element when the translation operation is performed. To this end, the normal mapping segment read from the nonvolatile memory device (130 of FIG. 15) may be provided to the translation section 244 and simultaneously provided to the operation memory device 242.

When the determination section 247 does not determine a replacement of the mapping segment, the data storage apparatus 220 may substantially maintain the normal mapping element, which is stored in the operation memory device 242, as is. Consequently, as compared with the case in which the normal mapping element is stored after the determination section 247 does not determine a replacement of the mapping segment, the data storage apparatus 220 may operate at a faster speed.

Referring to FIG. 25, in step S610, the normal mapping segment may be provided to the operation memory device 242 and the translation section 244. Then, step S620 and step S630 may be simultaneously performed.

In step S620, the provided normal mapping segment may be stored in the operation memory device 242.

In step S630, the translation section 244 may translate the normal mapping segment to the translation mapping segment.

In step S640, the determination section 247 may compare the size of the translation mapping segment with the determination reference size. The determination section 247 may determine whether the size of the translation mapping segment is smaller than the determination reference size. When the size of the translation mapping segment is smaller than the determination reference size (Yes), the procedure may proceed to step S650. When the size of the translation mapping segment is equal to or greater than the determination reference size (No), the procedure may proceed to step S670.

In step S650, the determination section 247 may determine to replace the normal mapping segment with the translation mapping segment.

In step S660, the translation mapping segment may be stored in the operation memory device 242. For example, the translation mapping segment may be overwritten on an area of the operation memory device 242 in which the normal mapping segment has been stored in step S620.

In step S670, the determination section 247 may determine not to replace the normal mapping segment with the translation mapping segment. The previously stored normal mapping segment is substantially maintained.

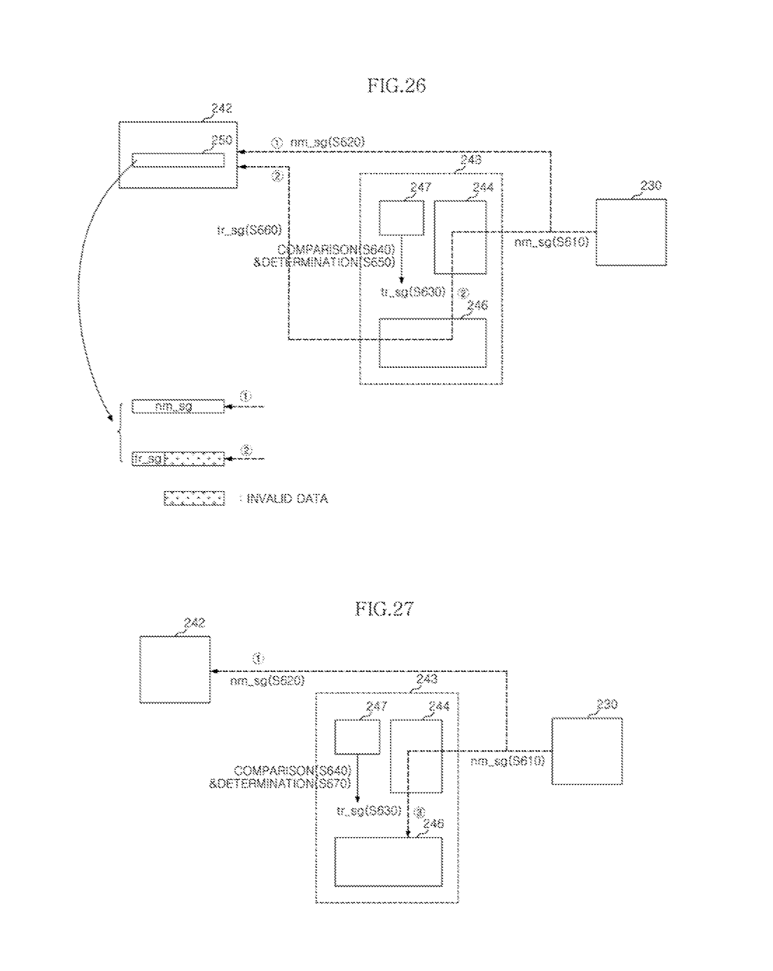

FIG. 26 and FIG. 29 are diagrams illustrating the flow of data that is transmitted in each step as the operation procedure of FIG. 25 is performed. In FIG. 26 and FIG. 29, the schematic flow of the translation mapping segment tr_sg and the normal mapping segment nm_sg is indicated by dotted lines.

FIG. 26 illustrates the flows \textcircled{1} and \textcircled{2} of data (the procedures \textcircled{1} and \textcircled{2} of FIG. 25) in which the normal mapping segment nm_sg stored in the nonvolatile memory device 230 is provided to the translation section 244 in step S610 and the determination section 247 determines to replace the normal mapping segment nm_sg with the translation mapping segment tr_sg in step S650. The normal mapping segment nm_sg may be preferentially stored in the memory area 250 of the operation memory device 242 according to the flow \textcircled{1}. Then, the translation mapping segment tr_sg may be overwritten on the memory area 250 of the operation memory device 242 according to the flow \textcircled{2}.

FIG. 27 illustrates the flows \textcircled{1} and \textcircled{3} of data (the procedures \textcircled{1} and \textcircled{3} of FIG. 25) in which the normal mapping segment nm_sg stored in the nonvolatile memory device 230 is provided to the translation section 244 in step S610 and the determination section 247 determines not to replace the normal mapping segment nm_sg with the translation mapping segment tr_sg in step S670. The normal mapping segment nm_sg preferentially stored in the operation memory device 242 in step S620 according to the flow \textcircled{1} may be substantially maintained.

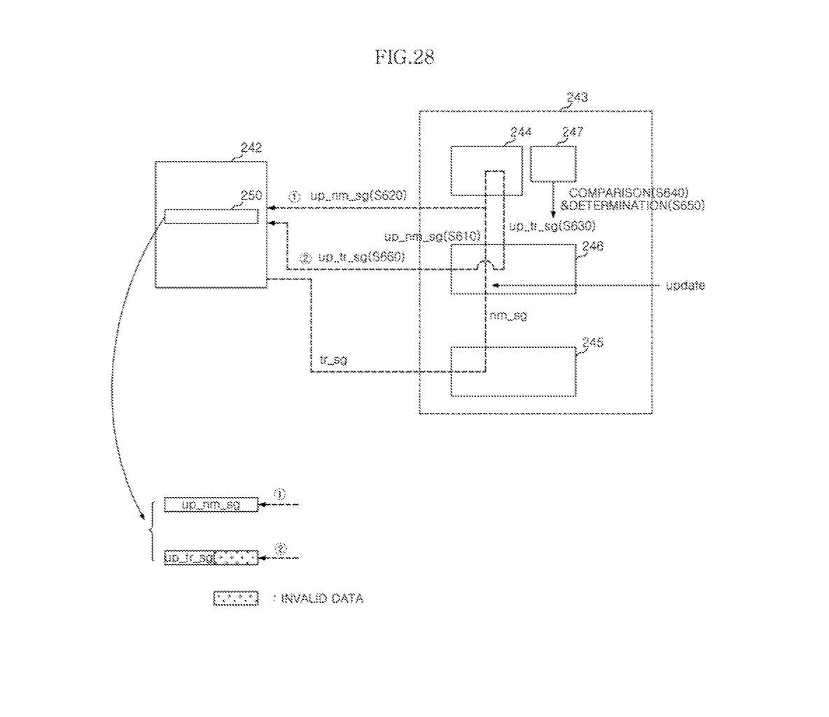

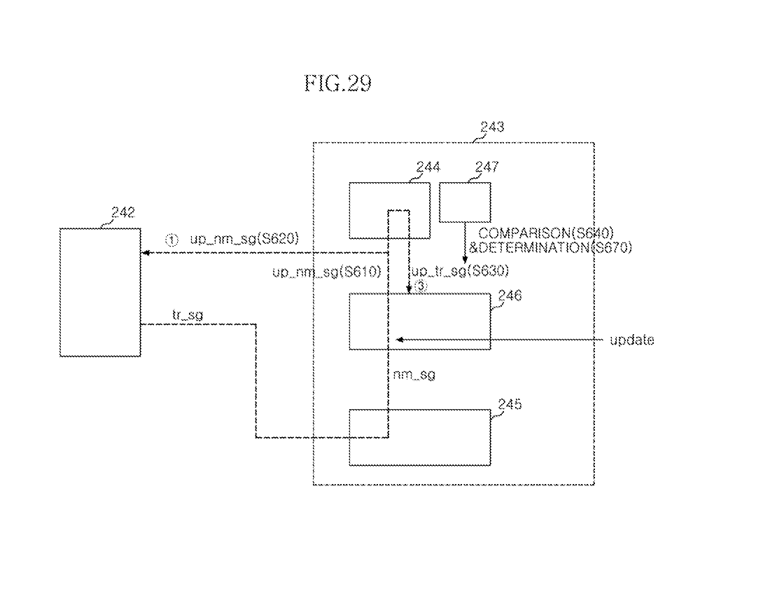

FIG. 28 illustrates the flows \textcircled{1} and \textcircled{2}, of data (the procedures \textcircled{1} and \textcircled{2} of FIG. 25) in which the updated normal mapping segment nm_sg is provided to the translation section 244 in step S610 and the determination section 247 determines to replace the updated normal mapping segment up_nm_sg with the updated translation mapping segment up_tr_sg in step S650. The updated normal mapping segment up_nm_sg may be preferentially stored in the memory area 250 of the operation memory device 242 in step S620 according to the flow \textcircled{1}. Then, the updated translation mapping segment up_tr_sg may be overwritten on the memory area 250 of the operation memory device 242 according to the flow \textcircled{2}.

FIG. 29 illustrates the flows \textcircled{1} and \textcircled{3} of data (the procedures \textcircled{1} and \textcircled{3} of FIG. 25) in which the updated normal mapping segment nm_sg is provided to the translation section 244 in step S610 and the determination section 247 determines not to replace the updated normal mapping segment up_nm_sg with the updated translation mapping segment up_tr_sg in step S670. The normal mapping segment nm_sg preferentially stored in the operation memory device 242 in step S620 according to the flow \textcircled{1} may be substantially maintained.

Referring to FIG. 28 and FIG. 29, for example, the translation mapping segment tr_sg provided from the operation memory device 242 may be inversely translated and updated in order to be provided as the updated normal mapping segment up_nm_sg.

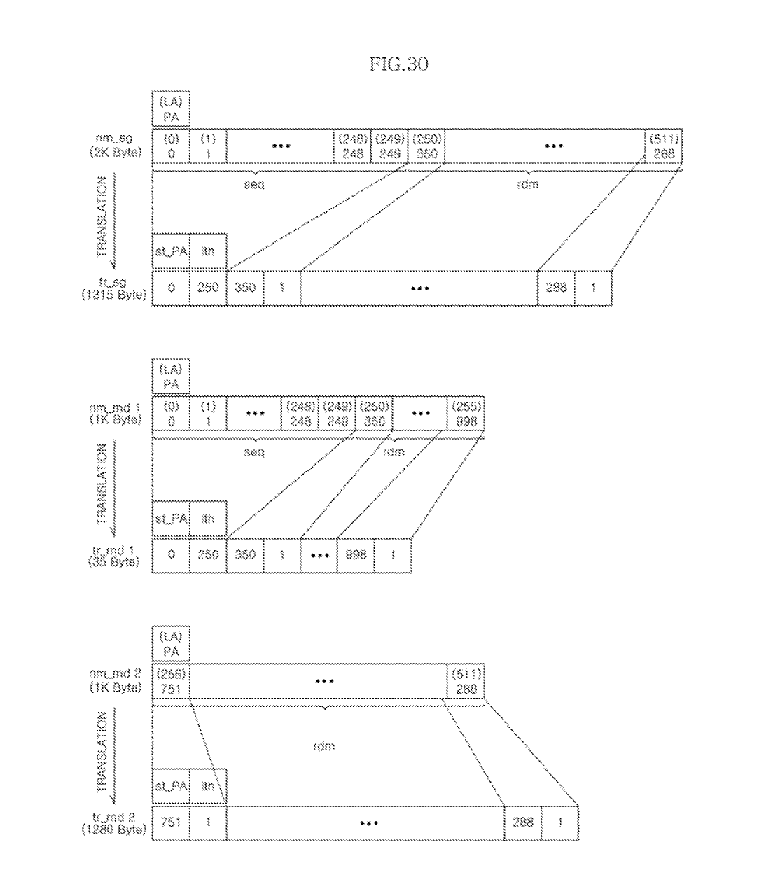

FIG. 30 is a diagram for explaining the case in which the unit of address mapping data, on which a translation operation and an inverse translation operation are performed, is changed.

The processing unit (243 of FIG. 15) according to the embodiment of the present invention may perform the translation operation and the inverse translation operation on the address mapping data (235 of FIG. 15) by various units. For example, the aforementioned processing unit 243 performs the translation operation and the inverse translation operation on the address mapping data 235 on a segment basis. That is, the processing unit 243 may perform the translation operation and the inverse translation operation by the unit in which normal address mapping data (that is, address mapping data including address mapping information on which no translation operation has been performed by the translation section (244 of FIG. 15) is received from the nonvolatile memory device (230 of FIG. 15). In another example, the processing unit 243 may perform the translation operation and the inverse translation operation by the unit that is smaller than the unit in which the normal address mapping data is received from the nonvolatile memory device 230. At this time, when a unit of address mapping data, on which the translation operation is performed, is changed, the determination section (247 of FIG. 15) may differently perform determination regarding a replacement with translation address mapping data (that is, address mapping data on which the translation operation has been performed by the translation section 244).

For example, FIG. 30 illustrates first normal address mapping data nm_md 1 and second normal address mapping data nm_md 2 divided from the normal mapping segment nm_sg. The first normal address mapping data nm_md 1 and the second normal address mapping data nm_md 2 include 1K bytes smaller than the segment size (that is, 2K bytes).

When the normal mapping segment nm_sg is translated to the translation mapping segment tr_sg, the normal mapping segment nm_sg may be translated from 2K bytes (=4 bytes×512) before the translation to 1315 bytes (=(4 bytes+1 byte)×263) after the translation. When the determination reference size is set as 512 bytes, since the size 1315 bytes of the translation mapping segment tr_sg is greater than the determination reference size 512 bytes, the determination section 247 may not determine a replacement with the translation mapping segment tr_sg. Accordingly, the normal mapping segment nm_sg is stored in the operation memory device 242.

When the first normal address mapping data nm_md 1 is translated to first translation address mapping data tr_md 1, the first normal address mapping data nm_md 1 may be translated from 1K bytes (=4 bytes×256) before the translation to 35 bytes (=(4 bytes+1 byte)×7) after the translation. When the determination reference size is set as 512 bytes, since the size 35 bytes of the first translation address mapping data tr_md 1 is smaller than the determination reference size 512 bytes, the determination section 247 may determine a replacement with the first translation address mapping data tr_md 1. Accordingly, the first translation address mapping data tr_md 1 is stored in the operation memory device 242.

When second normal address mapping data nm_md 2 is translated to second translation address mapping data tr_md 2, the second normal address mapping data nm_md 2 may be translated from 1K bytes (=4 bytes×256) before the translation to 1280s byte (=(4 bytes+1 byte)×256) after the translation. When the determination reference size is set to 512 byte, since the size 1280 bytes of the second normal address mapping data nm_md 2 is greater than the determination reference size 512 bytes, the determination section 247 may not determine a replacement with the second translation address mapping data tr_md 2. Accordingly, the second normal address mapping data nm_md 2 is stored in the operation memory device 242.

That is, when the translation section (244 of FIG. 15) performs the translation operation on a segment basis, that is, by the 2K bytes, the normal mapping segment nm_sg is stored in the operation memory device 242. However, when the translation section 244 performs the translation operation by the 1K bytes, the first translation address mapping data tr_md 1 and the second normal address mapping data nm_md 2 may be stored in the operation memory device 242. The operation memory device 242 may further ensure a storage space of 733 bytes (=2K bytes-(35 bytes+1280 bytes)) in the latter case more than the former case.

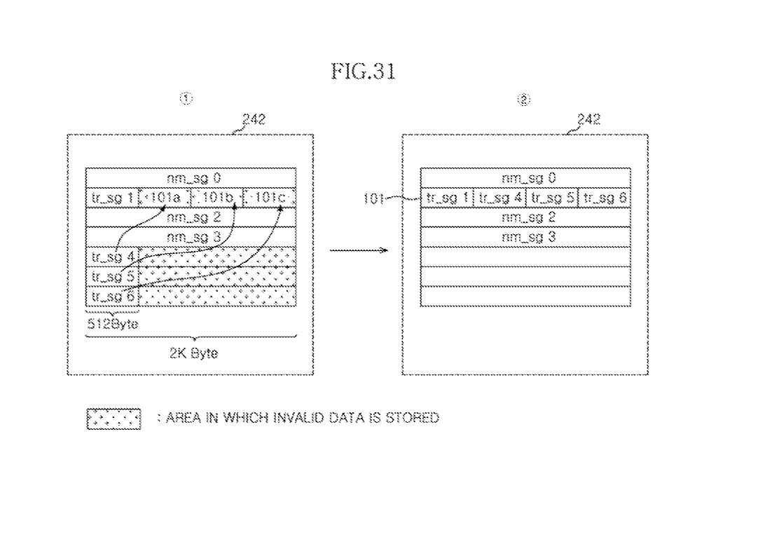

FIG. 31 is a diagram for explaining a data management method of the operation memory device 242.

\textcircled{1} illustrates the state in which invalid data remains when normal mapping segments and translation mapping segments, which have sizes different from each other, are stored in the operation memory device (242 of FIG. 15). For example, when the translation mapping segments are overwritten on a memory area in which the normal mapping segments have been stored, areas 101a to 101c may exist in which invalid data has been stored.

The areas 101a to 101c may be arranged in order to ensure an area in which the normal mapping segments may be stored. For example, a fourth translation mapping segment tr_sg 4 may be copied to the area 101a, a fifth translation mapping segment tr_sg 5 may be copied to the area 101b, and a sixth translation mapping segment tr_sg 6 may be copied to the area 101c.

\textcircled{2} illustrates the case in which the area capable of storing the normal mapping segments is ensured in the operation memory device 242.

While certain embodiments have been described above, it will be understood to those skilled in the art that the embodiments described are by way of example only. Accordingly, the data storage apparatus and the operating method thereof described herein should not be limited based on the described embodiments. Rather, the data storage apparatus and the operating method thereof described herein should only be limited in light of the claims that follow.

What is claimed is:

1. A data storage apparatus comprising:
a translation section suitable for performing a translation operation for translating first address mapping data to second address mapping data; and
an operation memory device suitable for storing the second address mapping data.

2. The data storage apparatus according to claim 1, wherein a size of the second address mapping data is smaller than a size of the first address mapping data.

3. The data storage apparatus according to claim 1, further comprising:
a microprocessor suitable for extracting address mapping information from the second address mapping data.

4. The data storage apparatus according to claim 3, wherein the microprocessor extracts a physical address corresponding to a logical address requested from a host apparatus as the address mapping information.

5. The data storage apparatus according to claim 1, further comprising:
a nonvolatile memory device suitable for backing up the first address mapping data.

6. The data storage apparatus according to claim 5, wherein the translation section performs the translation operation by a first unit in which the first address mapping data is provided from the nonvolatile memory device.

7. The data storage apparatus according to claim 5, wherein the translation section performs the translation operation by a second unit that is smaller than a first unit in which the first address mapping data is provided from the nonvolatile memory device.

8. The data storage apparatus according to claim 1, further comprising:
an inverse translation section suitable for performing an inverse translation operation for inversely translating the second address mapping data to the first address mapping data.

9. The data storage apparatus according to claim 8, wherein the inverse translation section performs the inverse translation operation when an update operation for reflecting new address mapping information in the first address mapping data is performed.

10. The data storage apparatus according to claim 8, wherein the inverse translation section performs the inverse translation operation for inversely translating the second address mapping data to be backed up.

11. A data storage apparatus comprising:
a translation section suitable for performing a translation operation for translating first address mapping data to second address mapping data;
a determination section suitable for determining whether to replace the first address mapping data with the second address mapping data based on a size of the second address mapping data; and
an operation memory device suitable for storing the second address mapping data or the first address mapping data based on a determination of the determination section.

12. The data storage apparatus according to claim 11, wherein the determination section is suitable for comparing the size of the second address mapping data with a determination reference size.

13. The data storage apparatus according to claim 12, wherein the determination section determines to replace the first address mapping data with the second address mapping data when the size of the second address mapping data is smaller than the determination reference size, and determines to maintain the first address mapping data when the size of the second address mapping data is equal to or greater than the determination reference size.

14. The data storage apparatus according to claim 12, wherein the determination reference size is set to be equal to or less than a size of the first address mapping data.

15. The data storage apparatus according to claim 11, wherein, when it is determined to replace the first address mapping data, the second address mapping data is stored in the operation memory device, and when it is determined to maintain the first address mapping data, the first address mapping data is stored in the operation memory device.

16. The data storage apparatus according to claim 11, wherein the operation memory device comprises:
a first memory area suitable for storing the first address mapping data; and
a second memory area suitable for storing the second address mapping data.

17. The data storage apparatus according to claim 11, wherein the operation memory device stores the first address mapping data when the translation operation is performed, and selectively store the second address mapping data based on the determination of the determination section.

18. The data storage apparatus according to claim 17, wherein, when it is determined to replace the first address mapping data, the operation memory device replaces stored first address mapping data with the second address mapping data, and when it is determined to maintain the first address mapping data, the operation memory device maintains the stored first address mapping data.

19. An operating method of a data storage apparatus comprising:
translating first address mapping data to second address mapping data;
comparing a size of the second address mapping data with a reference size;
determining whether to replace the first address mapping data with the second address mapping data based on a result of the comparing; and
selectively storing the second address mapping data and the first address mapping data in an operation memory device based on a result of the determining.

20. The operating method according to claim 19, the selective storing of the first and second address mapping data comprising:
storing the first address mapping data in the operation memory device when the first address mapping data is translated to the second address mapping data; and
replacing the first address mapping data stored in the operation memory device with the second address mapping data based on the result of the determining.
